(19) United States
(12) Patent Application Publication
(10) Pub. No.: US 2010/0044925 A1
(43) Pub. Date: Feb. 25, 2010

(54) NANOWIRE BUNDLES

(75) Inventors: Sunghoon Kwon, Seoul (KR); Wook Park, Seoul (KR)

Correspondence Address: KNOBBE MARTENS OLSON & BEAR LLP, 2040 MAIN STREET, FOURTEENTH FLOOR, IRVINE, CA, 92614, US

(73) Assignee: Seoul National University Industry Foundation, Seoul (KR)

(21) Appl. No.: 12/197,995

(22) Filed: Aug. 25, 2008

(51) Int. Cl. B29C 35/10

(52) U.S. Cl. 264/495; 425/174.4; 977/762

(57) ABSTRACT

Techniques for fabricating nanowire bundles are provided.

### BACKGROUND

Recent development of semiconductor technology has reduced the size of electronic component devices, particularly the width of lines in the devices. As a result, the importance of nanowires for electrically connecting devices is ever-increasing. Nanowires have a wide range of applications depending on relevant substances. For example, nanowires have been used for devices for emitting/receiving light (optical usage). Furthermore, nanowires have been added to composite materials (mechanical usage). Although nanowires can be potentially used in many fields, typical nanowires are limited with regard to shape and size.

### SUMMARY

In one embodiment, a method for fabricating nanowires comprises forming a number of nanowires by using a first portion of a fluidic channel, the first portion having a plurality of nanoscale holes on a surface of the first portion, and providing the nanowires into a second portion of the fluidic channel to control a stream of the nanowires flowing inside the second portion, the second portion having at least one roughness.

The Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a schematic diagram illustrating an apparatus for fabricating a nanowire bundle according to one illustrative embodiment.

FIG. 2a is a schematic diagram illustrating a fluidic channel of a nanowire bundle fabrication apparatus according to one illustrative embodiment.

FIG. 2b is a schematic diagram illustrating the section of the bottom side of a fluidic channel according to one illustrative embodiment.

FIG. 3 is a top view of a fluidic channel including first and second portions according to one illustrative embodiment.

FIG. 4 is a flow chart illustrating the method of fabricating nanowires according to one illustrative embodiment.

FIG. 5 is a top view of a first portion of a fluidic channel of a nanowire bundle fabrication apparatus according to another illustrative embodiment.

FIG. 6 is a top view of a first portion of a fluidic channel of a nanowire bundle fabrication apparatus according to still another illustrative embodiment.

FIG. 7 is a top view of a first portion of a fluidic channel of a nanowire bundle fabrication apparatus according to still another illustrative embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the components of the present disclosure, as generally described herein, and illustrated in the Figures, may be arranged, substituted, combined, and designed in a wide variety of different configurations, all of which are explicitly contemplated and make part of this disclosure.

In one embodiment, a method for fabricating nanowires includes forming a number of nanowires by using a first portion of a fluidic channel, the first portion having a plurality of nanoscale holes on a surface of the first portion, and providing the nanowires flowing into a second portion of the fluidic channel to control a stream of the nanowires flowing inside the second portion, the second portion having at least one roughness.

The nanowires may be formed by providing resins to the first portion of the fluidic channel, flowing the resins on a first side of each of the nanoscale holes on the first portion of the fluidic channel, and irradiating a second side of each of the nanoscale holes to at least partially cure the resins. The light may be UV light.

The roughness may include at least one groove formed on a bottom of the second portion of the fluidic channel. The groove may be oriented at an angle with regard to a longitudinal direction of the second portion of the fluidic channel. The predetermined angle may be larger than 0° and smaller than 180°. The second portion of the fluidic channel may have an anisotropic shape. The roughness may include a plurality of grooves formed on a bottom of the second portion of the fluidic channel. Further, the grooves may have different shapes.

The stream may be controlled to form the nanowires into a helical flow profile. The method may further include combining the nanowires formed into the helical flow profile to form a twisted nanowire bundle.

In another embodiment, an apparatus for fabricating nanowires comprises a fluidic channel including first and second portions. The first portion may have a plurality of nanoscale holes on a surface of the first portion, and resins flowing inside the first portion. The second portion may be connected to the first portion directly or indirectly. The second portion may have a shape corresponding to at least one roughness for controlling a stream of the resins flowing inside the second portion. The apparatus may further comprise a light source to irradiate the nanoscale holes existing on the first portion of the fluidic channel by a light. The light may be UV light.

In still another embodiment, a bundle of nanowires is fabricated by one of the above-mentioned methods.

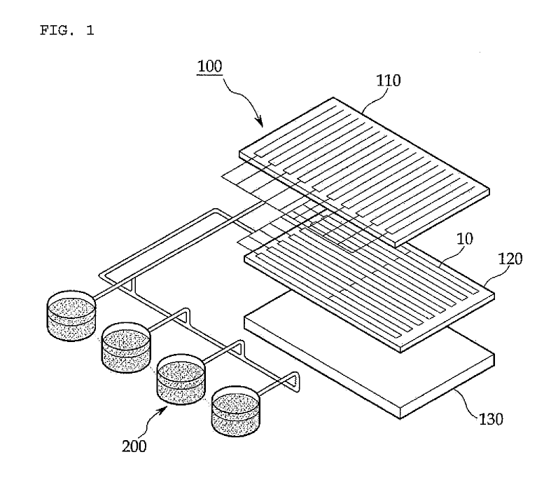

FIG. 1 is a schematic diagram illustrating an apparatus 100 for fabricating a nanowire bundle according to one illustrative embodiment. Fabrication apparatus 100 includes a fluid input control unit 110, to which fluid may be provided, a channel unit 120 positioned adjacent to the fluid input control unit 110 and provided with a plurality of fluidic channels 10, through which fluid provided to input control unit 110 may flow, and a light source 130 positioned adjacent the channel unit 120.

The fluid input control unit 110 may include a valve (not shown) to control fluid flow supplied to the channel unit 120 from a fluid supply unit 200. The amount and velocity of fluid supplied to the fluid input control unit 110 may be controlled by adjusting the valve.

The channel unit 120 may include a plurality of fluidic channels 10. Each fluidic channel 10 may include at least one inlet (not shown) to receive fluid from the fluid input control unit 110.

The light source 130 may include an optical structure to supply light. The light source may include, but is not limited to, a photonic crystal structure, a sensor, a source, and a waveguide.

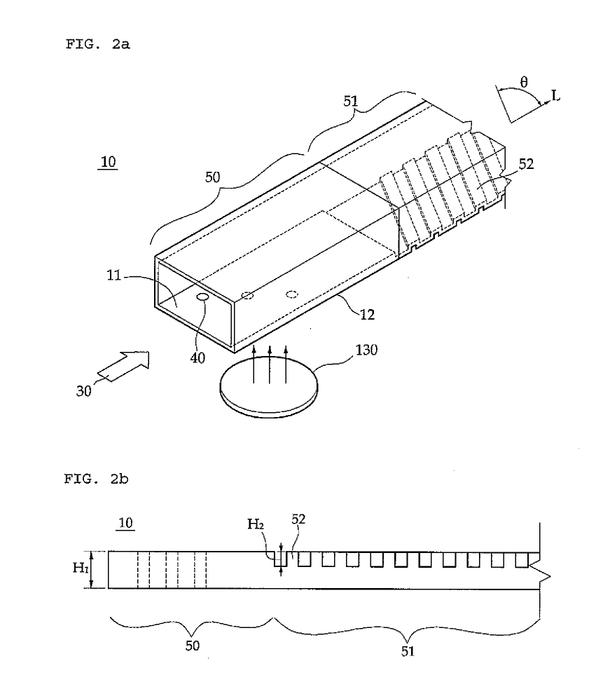

Construction of a fluidic channel 10 will now be described with reference to FIG. 2a and FIG. 2b. FIG. 2a is a schematic diagram illustrating a fluidic channel 10 according to one illustrative embodiment. FIG. 2b is a schematic diagram illustrating a sideview of fluidic channel 10. As shown in FIGS. 2a and 2b, fluidic channel 10 may include a first portion 50 to receive resin 30 provided by fluid input control unit 10 (FIG. 1) to form nanowires (not shown), and a second portion 51 having a roughness adapted to form the nanowires into a nanowire bundle (not shown).

The first portion 50 of the fluidic channel 10 includes a first side 11 having a plurality of nanoscale nanoholes 40 formed thereon, and a second side 12. The second side 12 may be irradiated by light emitted from light source 130. The number and structure of the nanoholes 40 may be varied depending on the structures and characteristics of the nanowires to be obtained, and are not limited to those shown in FIG. 2a or 2b. Although the nanoholes 40 are shown in FIG. 2a to have a circular shape, any shape (e.g. a triangle or a square) may be adopted for nanoholes 40.

The nanoholes 40 may be formed using various methods, which include, but are not limited to, electron beam lithography, two-photon lithography, and nanoimprinting. For example, the nanoholes 40 may be formed by depositing aluminum having a thickness of about 90 nm on a wafer, defining a pattern of nanoholes on a PMMA resist by electron beam lithography, and transferring the pattern to the aluminum layer by reactive ion etching. However, claimed subject matter is not limited with regard to how nanoholes 40 are fabricated.

The second portion 51 of the fluidic channel 10 may be directly connected to the first portion 50 so that second portion 51 may receive nanowires formed on first portion 50 and may form a nanowire bundle from the received nanowires. Alternatively, the second portion 51 may be indirectly connected to the first portion 50 by an additional element, as will be described later. The second portion 51 may be shaped to have a roughness formed on its surface in order to control the flow of nanowires over the surface. As used herein, the term roughness refers to a textured shape. Any shape or geometry may be adopted to obtain roughness (e.g. protrusions or grooves). As an example of the roughness, FIGS. 2a and 2b show a pattern of a plurality of grooves 52 formed in the second portion 51 of the fluidic channel 10. Referring to FIG. 2a, the pattern of the plurality of grooves 52 may be slanted or oriented at an angle (θ) with regard to the longitudinal direction L of the second portion 51 so that the second portion 51 may have an anisotropic shape. Again, the shape or orientation of the structure providing the roughness is not limited to that shown in FIG. 2a or 2b.

The angle (θ) may be larger than 0° and smaller than 180°, with regard to the longitudinal direction L of the second portion 51. Further, grooves 52 may have the same angle of orientation with regard to the longitudinal direction L of the second portion 51. Alternatively, respective grooves 52 may have different angles of orientation with respect to L.

Grooves 52 may have a height H₂ smaller than the height H₁ of the side of the second portion 51 in which grooves 52 are formed. The height H₂ of respective grooves 52 may be identical or may be different. Further, while the grooves 52 formed on the second portion 51 of the fluidic channel 10 are shown in FIGS. 2a and 2b as having the same shape, claimed subject matter is not limited in this regard and the roughness of the second portion 51 may be derived from any shape or structure as long as a surface roughness can be formed, as mentioned above.

The light source 130 may irradiate light into the fluidic channel through the nanoholes 40 in order to selectively cure resin 30 flowing inside the first portion 50. The light source 130 may be, but is not limited to, a UV lamp capable of emitting UV light. In addition, although the light source 130 is shown in FIG. 2a positioned below the fluidic channel 10, it may have any shape or position as long as it can irradiate light into the first portion 50 of the fluidic channel 10 through the nanoholes 40.

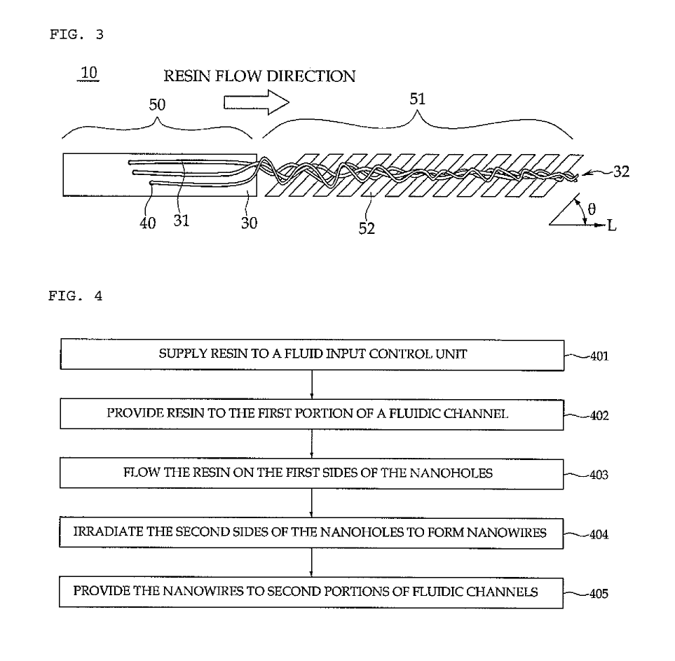

A method of fabricating nanowires according to one embodiment will now be described with reference to FIGS. 3 and 4. FIG. 3 is a top view of a fluidic channel 10 including first and second portions 50 and 51 according to one illustrative embodiment. FIG. 4 is a flow chart illustrating the method of fabricating nanowires according to one illustrative embodiment.

A resin 30 in liquid phase may be supplied from the fluid supply unit 200 (FIG. 1) to the fluid input control unit 110 (FIG. 1) (401 in FIG. 4). Resin 30 includes a photocurable resin, i.e. a resin that can be cured by light from the light source. When the light source 130 (FIG. 2a) is a TV lamp, for example, the resin 30 may be photocurable epoxy acrylate. The resin 30 provided to the fluid input control unit 110 may flow to the channel unit 120 (FIG. 1), and then through the respective first portions 50 of the plurality of fluidic channels 10 (402 in FIG. 4). The amount or velocity of the resin 30 provided to the channel unit 120 may be regulated by adjusting a valve (not shown) included in the fluid input control unit 110.

While the liquid resin 30 flows on the first side 11 (FIG. 2a) of a nanohole 40, the light source 130 may emit light to the second side 12 (FIG. 2a) of the nanohole 40 from which at least some of the emitted light may be absorbed by resin flowing past the first side 11 of the nanohole 40 (403 and 404 in FIG. 4). In response to light irradiated on the resin 30 flowing in the first portion 50 of the fluidic channel 10, the irradiated portion of the resin 30 may begin curing. Thus, as the liquid photocurable resin 30 flows past the nanohole 40, the resin 30 may be cured to form a single-strand nanowire 31. As the fluidic channel 10 has a plurality of nanoholes 40, as mentioned above, a plurality of single-strand nanowires 31 may be obtained from the nanoholes 40 in this manner.

According to one embodiment, the nanoholes 40 may be arranged at a predetermined angle with regard to the direction of flow of the resin (as indicated by the arrow in FIG. 3). In the illustrative embodiment of FIG. 3, the nanoholes 40 are formed along a direction inclined at a single angle with regard to the direction of flow of the resin. With the arrangement of nanoholes 40 as shown in FIG. 3, nanowires may be formed continuously without overlapping each other.

Once formed in the first portion 50, the single-strand nanowires 31 may continuously flow into the second portion 51 of the fluidic channel 10 (405 in FIG. 4). The second portion 51 may have a roughness formed at an angle with regard to the longitudinal direction L of the second portion 51. For example, as mentioned above, the roughness may be provided by a groove pattern slanted at an angle θ with regard to the longitudinal direction of the second portion 51, and the grooves may have a height H₂ (FIG. 2b) smaller than the height H₁ (FIG. 2b) of the side of the second portion 51 on which they are formed. However, the present disclosure is not limited to this embodiment.

A plurality of single-strand nanowires 31 may flow through the second portion 51 together with fluid including the remaining resin which has not been polymerized. The motion of the fluid including the single-strand nanowires 31 may be controlled by the pattern of grooves 52 formed inside the second portion 51. Particularly, a transverse pressure gradient may be generated by the pattern of grooves 52 formed inside the second portion 51. Recirculation generated by the pressure gradient may cause the single-strand nanowires 31 to rotate within the region of the second portion 51. By such mechanism, the stream of nanowires 31 included in the fluid may form a helical flow profile. In response to a helical flow profile the single-strand nanowires 31 may form a single twisted nanowire bundle 32, as shown in FIG. 3.

The twisted nanowire bundle 32 fabricated in the second portion 51 of the fluidic channel 10 may exit from the second portion 51 while being included in the fluid resin 30. A nanowire bundle fabrication apparatus according to one embodiment may further include a device (not shown) to remove the fluid resin 30 to obtain the nanowire bundle.

According to some embodiments, a nanowire bundle fabrication apparatus may have a resin removal device (not shown) and a fluid introduction device (not shown). Such devices may be installed between the first and second portions 50 and 51 of the fluidic channel 10. The resin removal device may be adapted to remove the fluid resin, which is not cured but is flowing together with the cured resin in the first portion 50. As a result, the single-strand nanowires 31 without the fluid resin may be obtained from the second portion. The fluid introduction device may be connected to the resin removal device to supply the second portion 51 with the extracted single-strand nanowires 31. For example, the fluid introduction device may be adapted to supply the second portion 51 with a fluid (e.g. water) together with the single-strand nanowires 31 extracted by the resin removal device.

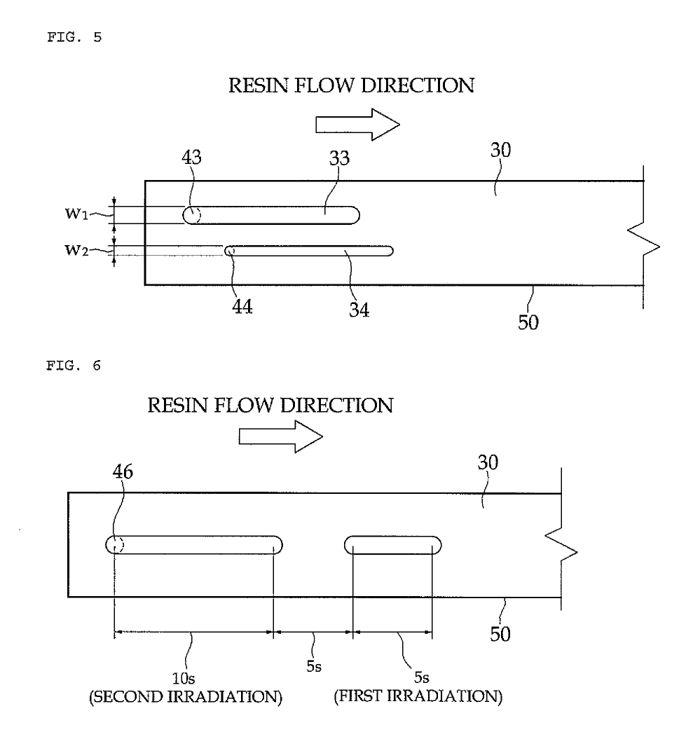

According to some embodiments, a nanowire bundle fabrication apparatus may include various sizes of nanoholes to create nanowires with different widths. FIG. 5 is a top view of a first portion 50 of a fluidic channel according to another illustrative embodiment. In FIG. 5, an arrow indicates a flow direction of resin 30. An upper nanohole 43 of portion 50 has a width W₁ larger than the width W₂ of a lower nanohole 44. As a result, the nanowire 33 formed by the nanohole 43 has a width larger than that of the nanowire 34 formed by the nanohole 44.

FIG. 6 is a top view of a fluidic channel of a nanowire bundle fabrication apparatus according to still another illustrative embodiment. Although only one nanohole 46 is illustrated in FIG. 6 for brevity, the present disclosure is not limited in this regard. In FIG. 6, an arrow indicates a flow direction of resin 30. FIG. 6 shows two irradiation events. In particular, the resin 30 may be irradiated with light through nanohole 46 for a short interval (e.g., a first exposure of about five seconds). After an interval without irradiation (e.g., another five seconds), the resin is irradiated with light through the same nanohole 46 for another, longer, interval (e.g., a second exposure of about ten seconds). Assuming that the resin 30 flows at a velocity of about 100 nm/s, the first exposure may create a nanowire having a length of about 500 nm, and the second exposure may create a nanowire having a length of about 1 μm. By controlling the time duration and interval of irradiation in this manner, single-strand nanowires of different lengths may be obtained.

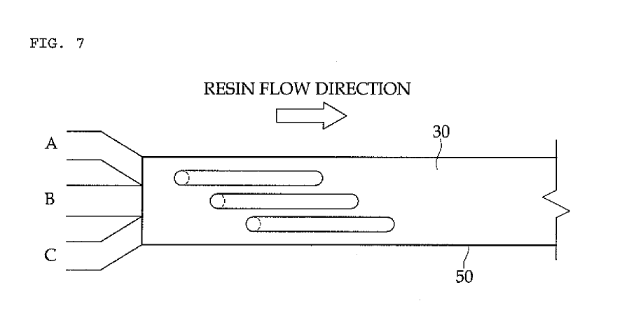

FIG. 7 is a top view of a first portion 50 of a fluidic channel according to another illustrative embodiment. In this embodiment, the channel unit 120 (FIG. 1) includes a plurality of inlets to supply resin to the first portion 50 of each fluidic channel 10. Although FIG. 7 shows three inlets (A, B and C) connected to the fluidic channel 10, the number of inlets is not limited to three. Liquid resin 30 may be supplied to the first portion 50 of the fluidic channel from inlets A, B, and C, respectively. The arrow indicates the flow direction of resin 30 inside the fluidic channel 10. Resin 30 provided by inlets A, B and C may include resins of the same composition, or different compositions. A plurality of sub-channels (not shown) may be arranged inside the first portion 50 so that the resins 30 do not mix with each other inside the fluidic channel 10. Alternatively, respective resins provided by inlets A, B and C may be under laminar flow conditions so that the resins do not mix with each other inside the first portion 50. The resin 30 may be supplied into and flow through the first portion 50 without intermixing. In response to the light irradiated to the resin 30, single-strand nanowires may be formed from respective resins provided by inlets A, B and C. When the resins provided by inlets A, B and C have different compositions, nanowires having different compositions may be fabricated concurrently and provided to the second portion 51 of the fluidic channel to form a nanowire bundle of mixed composition.

Nanowire bundles fabricated in accordance with claimed subject matter may be used for applications such as solar cells, textiles, and biosensors, to name only a few. For example, a solar cell may be fabricated in the form of a plastic cover or paint using nanowire bundles. In another example, nanowire bundles may be used to fabricate textiles. Further, nanowire bundles may be used to form a nano biosensor. However, those skilled in the art can understand that the present disclosure is not limited to the above-mentioned example applications.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A method of fabricating nanowires comprising:
forming a plurality of nanowires in a first portion of a fluidic channel, the first portion having a plurality of nanoscale holes in a surface of the first portion; and
providing the nanowires to a second portion of the fluidic channel, the second portion having a structure corresponding to at least one roughness.

2. The method of claim 1, wherein forming the plurality of nanowires comprises;
providing resin to the first portion of the fluidic channel;
flowing the resin adjacent to a first side of each of the nanoscale holes; and
irradiating a second side of each of the nanoscale holes to at least partially cure the resin.

3. The method of claim 1, wherein the roughness comprises at least one groove formed in the second portion of the fluidic channel.

4. The method of claim 3, wherein the groove comprises a groove disposed at an angle with regard to a longitudinal direction of the second portion of the fluidic channel.

5. The method of claim 4, wherein the angle comprises an angle larger than 0° and smaller than 180°.

6. The method of claim 1, wherein the structure of the second portion of the fluidic channel comprises an anisotropic shape.

7. The method of claim 1, wherein the structure of the second portion comprises a plurality of grooves having different shapes.

8. The method of claim 1, further comprising using the structure of the second portion to form the nanowires into a helical flow profile.

9. The method of claim 8, further comprising using the structure of the second portion to combine the nanowires in the helical flow profile to form a twisted nanowire bundle.

10. The method of claim 2, wherein the resin comprises photocurable resin.

11. The method of claim 2, wherein irradiating the second side of each the nanoscale holes comprises irradiating the second side of each of the nanoscale holes with UV light.

12. An apparatus for fabricating nanowires, comprising:
a fluidic channel comprising first and second portions, the first portion having a plurality of nanoscale holes, the fluidic channel adapted to permit resin to flow in the first and second portions, the second portion being coupled to the first portion directly or indirectly, the second portion having at least one roughness; and
a light source to irradiate the nanoscale holes.

13. The apparatus of claim 12, wherein the roughness comprises at least one groove formed in the second portion of the fluidic channel.

14. The apparatus of claim 13, wherein the groove comprises a groove disposed at an angle with regard to a longitudinal direction of the second portion of the fluidic channel.

15. The apparatus of claim 14, wherein the angle comprises an angle larger than 0° and smaller than 180°.

16. The apparatus of claim 12, wherein the second portion of the fluidic channel has an anisotropic shape.

17. The apparatus of claim 12, wherein the roughness comprises a plurality of grooves formed in the second portion of the fluidic channel, the grooves having different shapes.

18. The apparatus of claim 12, wherein the second portion of the fluidic channel is configured to form the stream of the resin into a helical flow profile.

19. The apparatus of claim 12, wherein the resin comprises photocurable resin.

20. The apparatus of claim 12, wherein the light source comprises a UV light source.
